(19) United States
(12) Patent Application Publication
(10) Pub. No.: US 2025/0348328 A1
(43) Pub. Date: Nov. 13, 2025

(54) ENHANCED PLATFORM CAPABILITY DESCRIPTION-BASED APPROACH FOR POWER SUBSTATION CONFIGURATION MANAGEMENT

(71) Applicant: GE Vernova Infrastructure Technology LLC, Greenville, SC (US)

(72) Inventors: Balakrishna PAMULAPARTHY, Hyderabad (IN); Mitalkumar KANABAR, Markham (CA); Patrick MONTANER, Montpellier (FR); David MACDONALD, Barcelona (ES); Bo Su, Markham (CA); Norbert ARMAND, Montpellier (FR)

(73) Assignee: GE Vernova Infrastructure Technology LLC, Greenville, SC (US)

(21) Appl. No.: 18/662,196

(22) Filed: May 13, 2024

(51) Int. Cl. G06F 9/445

(52) U.S. Cl. CPC G06F 9/44505

(57) ABSTRACT

Devices, systems, and methods for platform capability description (PCD) file-based configuring of intelligent electronic devices (IEDs) may include generating, by at least one processor, PCD files for an IED, the PCD files defining the capabilities of the IED, a license of functions of the IED for a user, and rules applying to settings of the IED; generating, using an IED configurator tool from which IED rules are absent, based on the PCD files, a bundle of files for the IED, the bundle comprising a manifest and configuration files for the IED; and providing, by the IED configurator tool, to the IED, the bundle, the license of functions, and the rules, wherein the IED is configured based on the bundle, the license of functions, and the rules.

### TECHNICAL FIELD

This disclosure generally relates to power substation configuration management, and more particularly to a platform capability description-based approach for power substation Protection and Control configuration management.

### BACKGROUND

Intelligent electronic devices (IEDs) are computerized protection devices and controllers of power system equipment. The International Electrotechnical Commission (IEC) 61850 standard defines the data models, the engineering process and communication protocols for power substation IEDs, including an IED configurator tool (ICT) that facilitates configuration of IEDs. However, ICTs are specific to IED families, so new and different IEDs require different ICTs.

### SUMMARY

A method for platform capability description (PCD) file-based configuring of intelligent electronic devices (IEDs) may include generating, by at least one processor, PCD files for an IED, the PCD files stating capabilities of the IED, an International Electrotechnical Commission (IEC) 61850 data model, a license of functions of the IED for a user, and rules applying to settings of the IED; generating, using an IED configurator tool from which IED rules are absent, based on the PCD files, a bundle of files for the IED, the bundle comprising a manifest and configuration files for the IED; and providing, by the IED configurator tool, to the IED, the bundle, the license of functions, and the rules, wherein the IED is configured based on the bundle, the license of functions, and the rules.

An intelligent electronic device (IED) configurator device may include memory coupled to at least one processor configured to: load platform capability description (PCD) files for an IED, the PCD files stating capabilities of the IED, an international Electrotechnical Commission (IEC) 61850 data model, a license of functions of the IED for a user, and rules applying to settings of the IED; generate, based on the PCD files, a bundle of files for the IED, the bundle comprising a manifest and configuration files for the IED; and provide, to the IED, the bundle, the license of functions, and the rules, wherein the IED is configured based on the bundle, the license of functions, and the rules, and wherein IED rules are absent from the IED configurator device.

A non-transitory computer-readable medium storing computer-executable instructions which when executed by at least one processor of an intelligent electronic device (IED) configurator device for capability description (PCD) file-based configuring of IEDs, may cause the at least one processor to: load platform capability description (PCD) files for an IED, the PCD files stating capabilities of the IED, an International Electrotechnical Commission (IEC) 61850 data model, a license of functions of the IED for a user, and rules applying to settings of the IED; generate, based on the PCD files, a bundle of files for the IED, the bundle comprising a manifest and configuration files for the IED; and provide, to the IED, the bundle, the license of functions, and the rules, wherein the IED is configured based on the bundle, the license of functions, and the rules, and wherein IED rules are absent from the IED configurator device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates example process flows for configuring intelligent electronic devices (IEDs) using IED configuration tools (ICTs) in accordance with one embodiment of the present disclosure.

FIG. 2 illustrates an example process for configuring IEDs in accordance with one embodiment of the present disclosure.

FIG. 3 illustrates an example process for configuring an IED using an ICT in accordance with one embodiment of the present disclosure.

FIG. 4 illustrates an example platform capability description (PCD)-based process for configuring an ICT in accordance with one embodiment of the present disclosure.

FIG. 5 illustrates an example PCD-based process for configuring an IED using an ICT in accordance with one embodiment of the present disclosure.

FIG. 6 is a diagram illustrating an example of a computing system that may be used in implementing embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Devices of power transformers, such as relays, switches, transformers, circuit breakers, and the like, may be processor-controlled as intelligent electronic devices (IEDs). The configuration of an IED, such as its name, addresses, parameters, data sets, protection settings and the like, may be controlled by an IED configurator tool (ICT). The International Electrotechnical Commission (IEC) 61850 standard defines communication protocols for power substation IEDs, including ICTs for different families of IEDs. A system configuration tool (SCT) may load IED configuration description (ICD) files specific to a manufacturer/family of IEDs, and may generate a substation configuration description (SCD) for a power substation based on its ICDs for respective IEDs of the power substation. ICTs may load the SCD to configure respective IEDs of a power substation.

One drawback of the current IED configuration is that the ICTs are device family-specific, so new and different IED families require new ICTs, which limits the speed and ability to develop new IED device families. In addition, users of IEDs may use only a subset of the many functions that an IED may perform, and there is currently no way to limit a user to only the subset of IED functions. As a result, users often pay for IED functionality that they do not use.

ICD files are often hardcoded, making the relevant data model inflexible. However, sophisticated IED users increasingly want to define their own data model for IEDs, including not just which logical nodes are implemented, but also device naming, prefixes and suffixes.

The present disclosure improves IED configuration using ICTs by providing an IED-agnostic ICT. The IED-agnostic ICT herein may be file-based, specifically, a platform capability description (PCD)-based. By using a set of PCD files defining IED capabilities, a license to restrict IED use to certain IED capabilities, a mapping file, and rules and layout files, then the right set of files may allow an ICT to use any IED platform in an IED-agnostic manner. A new IED platform would only require a new file rather than a new ICT. The PCD-based solution may be a fully flexible data model in which any data point may be mapped to any IEC 61850 address, a for which an IED user may receive a license only for agreed to IED functionalities.

The enhanced configuration process herein addresses the following uncertainties: (1) the data model required by an IED user, (2) the amount that an IED user is willing to pay for IED use, and (3) as the requirements of future new IED platforms.

The IEC 61850 standard defines communications using system configuration description language (SCL) files. The SCL files are based on an XML syntax that may be manipulated by applications such as protection coordination tools and may be used to streamline the existing IED configuration process as defined herein. The enhanced IED configuration process herein permits an IED-independent system configuration tool to perform the entire IED configuration without needing proprietary software or communications. The IED protection settings may be performed at a system level rather than on a per-device basis.

In one or more embodiments, the PCD files may include domain-specific language (DSL) files as inputs for an ICT so that the ICT may understand what an IED family may support (e.g., in terms of inputs/outputs, functionality, maximum capacity, etc.). DSL files refer to an input file for the ICT so that the ICT may understand what an IED platform family may support (e.g., in terms of inputs/outputs, functionality, maximum capacity, and the like). A new IED platform would require new DSL files instead of a new ICT. The PCD files also may include a license that an IED user may purchase, the license defining which IED functionalities to be can be activated within the IED. A license may be purchased by a user, and may indicate to the ICT, which function(s) may or may not be applied for the user. The PCD files also may include a mapping file (e.g., an IEC 61850 mapping) that may include the data model required by an IED user and that the ICT is to implement. The PCD files also may include rules files for ICT-specific rules, such as when certain IED settings should be available, hidden, or need to be changed. The rules allow for managing Order Code so that no specific code needs to be in the IED.

In one or more embodiments, the ICT may send the license, rules, and a bundle (e.g., a manifest, a security configuration, and other configurations) to an IED. Currently, ICTs do not provide any license or rules to an IED. The ICT may generate IEC 61850 files, including an ICD. In this manner, the ICD file generated by the ICT is no longer hardcoded.

In one or more embodiments, the enhanced IED configuration herein may be virtual or physical using a platform capability approach that limits or eliminates any specific hardcoded IED behavior within an ICT tool. The enhanced approach may provide IED user flexibility in specifying, adding, or configuring required IED logical nodes. The enhanced approach may provide a seamless separation of application model from the IEC 61850 model. The enhanced approach may allow the automated selection of platform capability based on high-level application choices. The enhanced approach may provide file-based separation of the IEC 61850 mapping and the device model or family-specific DSL file to replace an ICD. The file-based data model herein provides a consistent data model to be held across many different families of IEDs. The IEC 61850 data model may be updated easily as a result of the enhancements herein to accommodate new logical nodes and data objects, whether from updates to IEC 61850 (e.g., parts 7-3 and 7-4) or requests from IED users.

The above descriptions are for purposes of illustration and are not meant to be limiting. Numerous other examples, configurations, processes, etc., may exist, some of which are described in greater detail below. Example embodiments will now be described with reference to the accompanying figures.

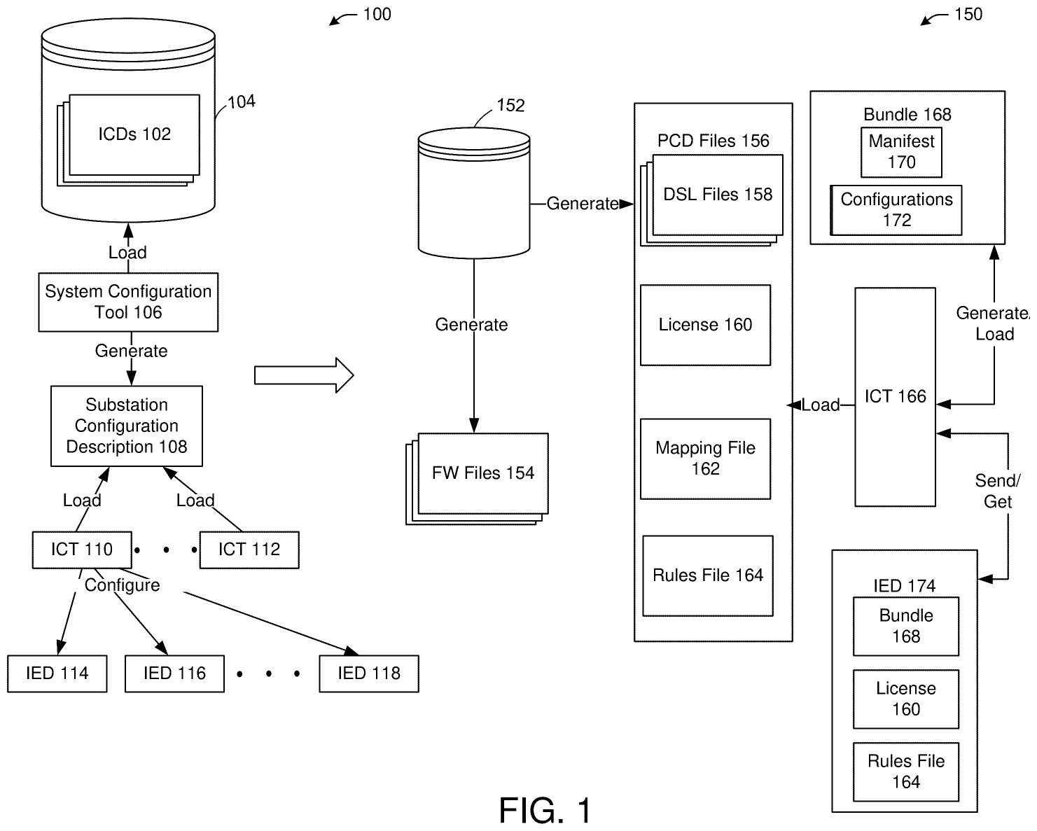

FIG. 1 illustrates example process flows for configuring intelligent electronic devices (IEDs) using IED configuration tools (ICTs) in accordance with one embodiment of the present disclosure.

Referring to FIG. 1, a first process flow 100 for configuring IEDs using an ICT may be based on the IEC 61850 standard. ICDs 102 for various manufacturers may be stored in an ICD database 104. A system configuration tool (SCT) 106 may load the ICDs 102, and may generate a substation configuration description (SCD) 108 based on the ICDs 102. ICTs (e.g., ICT 110, . . . , ICT 112) may load the SCD 108 for respective IEDs, and may use the SCD 108 to configure IEDs (e.g., IED 114, IED 116, . . . , IED 118). In this manner, the ICTs 110 and 112 may be family/manufacturer specific (e.g., each ICT may correspond to one or more of the ICDs 102, but different IEDs from different IED families may require a different ICT).

Still referring to FIG. 1, a second process flow 150 for configuring IEDs using an ICT may be IED-agnostic. A database 152 (or other generation tool) may generate firmware (FW) files 154, and may generate PCD files 156. The PCD files may include DSL files 158, a license 160 (e.g., defining which IED functions a user is licensed to use), a mapping file 162 (e.g., mapping IED functions to respective IEC 61850 addresses-this file may include a data model required by a user that an ICT may implement), and a rules file 164 (e.g., ICT-specific rules defining which IED settings should be available, hidden, changed, and when). An ICT 166 may load the PCD files 156, and may generate and load a bundle 168. The bundle 168 may include a manifest file 170 and configuration files 172 (e.g., a security configuration, an IEC 61850 configuration, an applicative configuration, etc.). The ICT 166 may send to an IED 174 (and get from the IED 174) the bundle 168, the license 160, and the rules file 164 (e.g., collectively, the PCD files 156). The IED 174 may use the PCD files 156 to configure and operate, and to control which IED functions (e.g., a subset of the overall IED functions) to allow a user to use based on the license 160. For example, the IED 174 may configure various of its nodes based the bundle 168, may implement the data model of the mapping file 162, and may determine which IED settings should be available, hidden, or changed based on the rules file 164. In this manner, the ICT 166 may be IED family-agnostic.

In one or more embodiments, any PCD file of the PCD files 156 may include a description from an applicative point of view of services (e.g., IEC 61850 and others) available, and common functionalities from an IED platform (e.g., of an IED manufacturer). The ICT 166 may not include any specific IED or IED platform behavior information or rules.

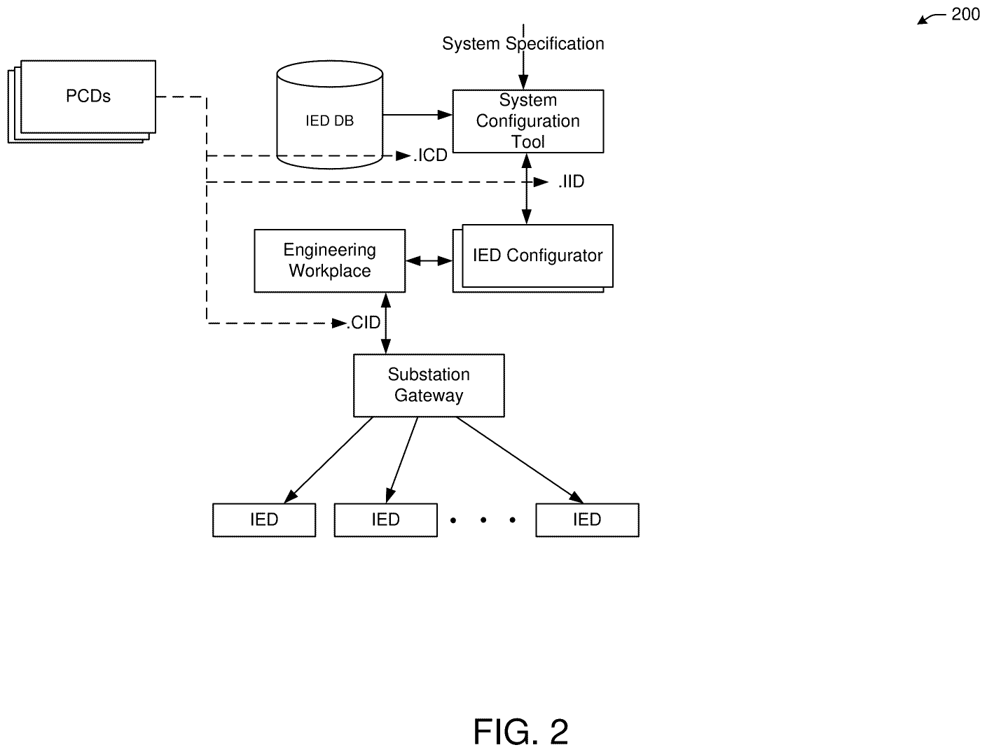

FIG. 2 illustrates an example process 200 for configuring IEDs in accordance with one embodiment of the present disclosure.

Referring to FIG. 2, the process 200 may represent configuration operations defined by the IEC 61850-6:2009 standard (2018) in which IED capabilities (e.g., PCDs) from an IED database may be provided to san ICT, along with system specifications (e.g., single line, etc.). The PCDs may configure the ICT so that the ICT may import .SCD files or export .ICD and .IID files. The system configurator may provide the .SCD files to an IED configurator, which may provide an instantiated IED to the system configurator. The IED configurator may use an engineering workplace to perform file transfers (e.g., both local and remote) to IEDs (e.g., remote file transfers performed via a substation gateway).

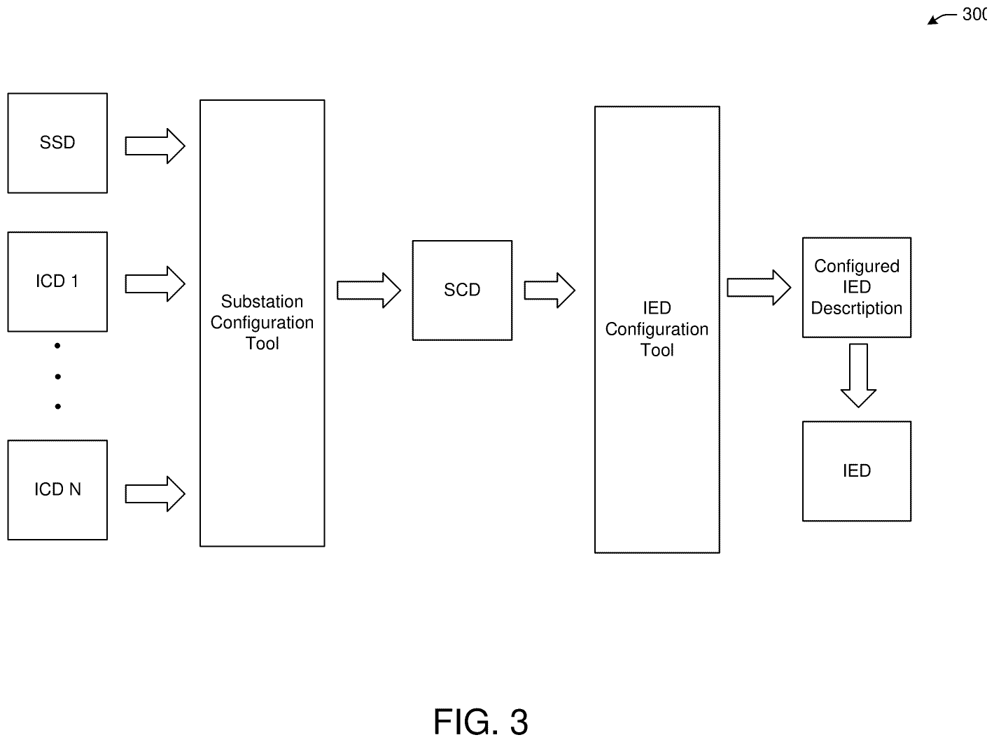

FIG. 3 illustrates an example process 300 for configuring an IED using an ICT in accordance with one embodiment of the present disclosure. For example, the process 300 may represent the standard IEC 61850 engineering workflow.

Referring to FIG. 3, a substation configuration tool (SCT) may load system specification description (SSD) and ICD files (e.g., ICD 1-ICD N). The SSD files may represent system configuration description language (SCL) files defined by the IEC 61850 standard. The SCT may use the SSD and ICD files to generate a substation configuration description (SCD) file, which an ICT (e.g., a manufacturer-specific ICT) may use to generate a configured IED description (CID) file. An IED may implement the CID file for configuration.

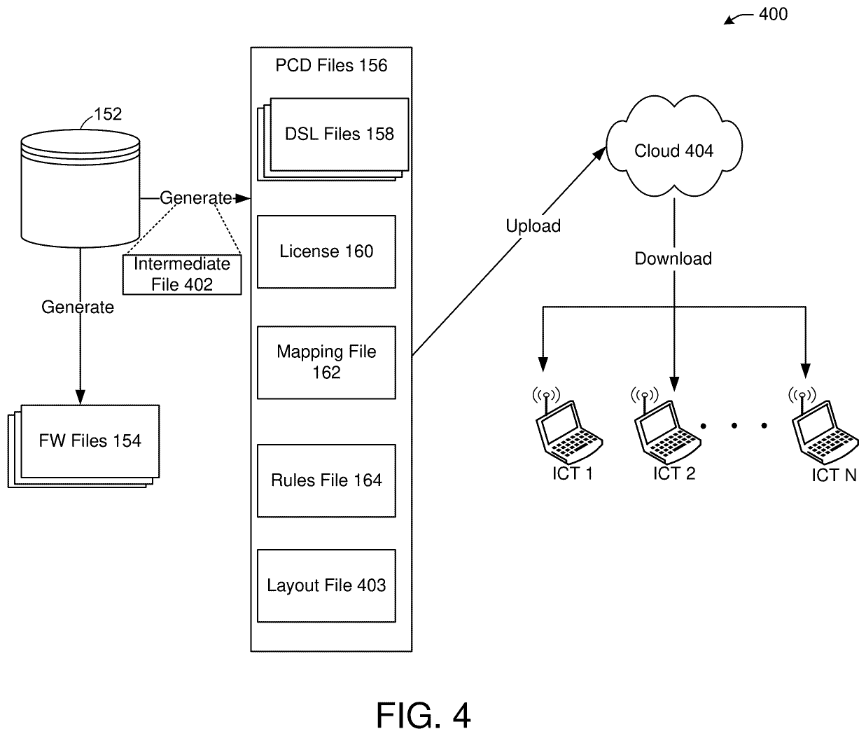

FIG. 4 illustrates an example PCD-based process 400 for configuring an ICT in accordance with one embodiment of the present disclosure.

Referring to FIG. 4, the database 152 of FIG. 1 may store the FW files 154, and may generate the PCD files 156 (e.g., using an intermediate file 402, which may be a .xml file), including a layout file 403. The PCD files 156 may be uploaded to a cloud 404 (e.g., one more remote servers/storage resources), and may be downloaded from the cloud 404 to respective ICTs (e.g., ICT 1, ICT 2, . . . , ICT N). By using the PCD files 156, the ICTs may be IED family-agnostic, and may be limited to a subset of IED functions based on the license 160, for example.

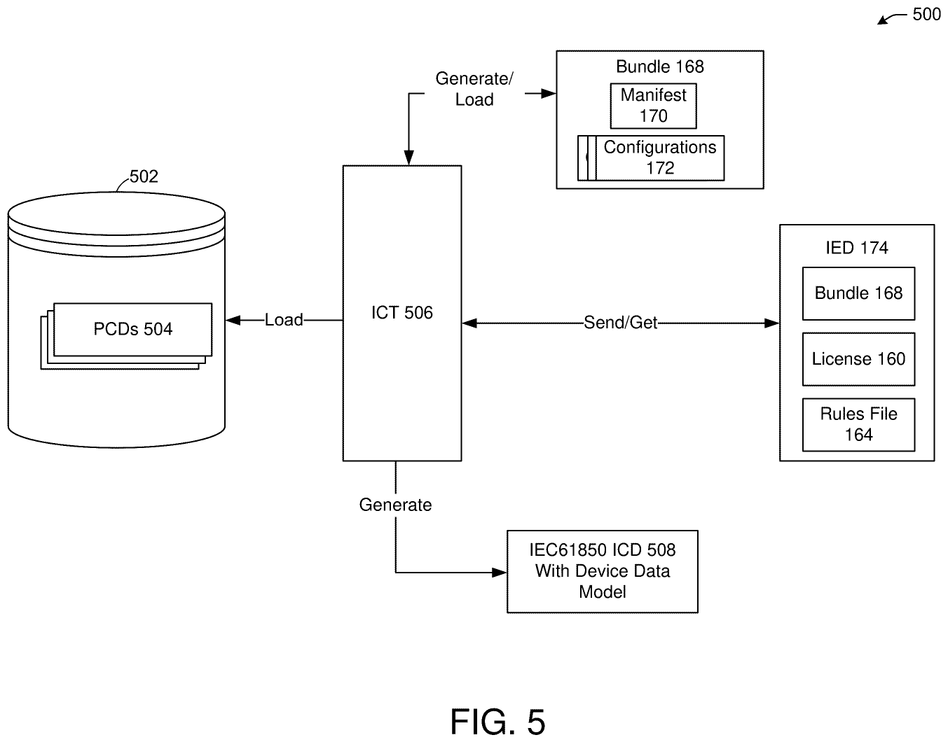

FIG. 5 illustrates an example PCD-based process 500 for configuring an IED using an ICT in accordance with one embodiment of the present disclosure.

Referring to FIG. 5, a local ICT database 502 may serve as a PCD data storage for PCD files 504 (e.g., each representing a set of the PCD files 156 of FIG. 1). An ICT 506 may load the PCD files 504. The ICT 506 may generate IEC 61850 files 508 (e.g., ICD files, IID files referring to instantiated IED files that define IED configurations) and use them to generate and load the bundle 168. The ICT 506 may send to and get from the IED 174 of FIG. 1 the bundle 168, the license 160, and the rules file 164.

In one or more embodiments, because the ICT 506 may not be hardcoded with IED rules for any specific IED manufacturer, the ICT 506 may generate different respective IED files/bundles for different respective IEDs using the different PCD files 504, allowing the ICT 506 to be IED family-agnostic.

In one or more embodiments, the IEDs configured by the enhanced configuration here may be physical and/or virtual IEDs.

It is understood that the above descriptions are for purposes of illustration and are not meant to be limiting.

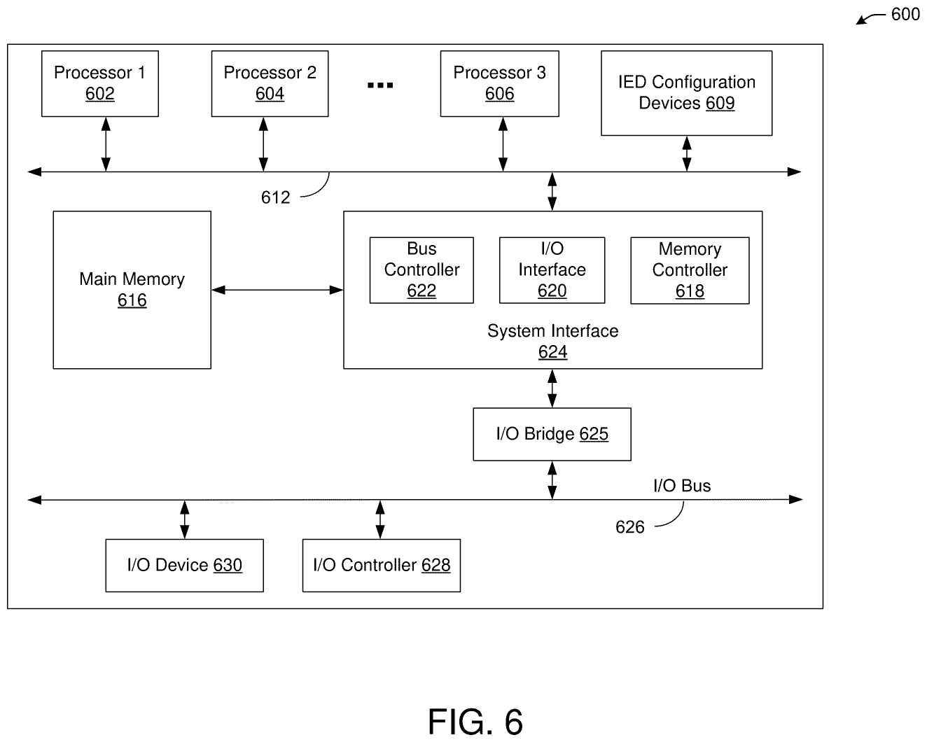

FIG. 6 is a diagram illustrating an example of a computing system 600 that may be used in implementing embodiments of the present disclosure.

The computer system 600 (system) includes one or more processors 602-606 and IED configuration devices 609 (e.g., representing the database 152 of FIG. 1, the ICT 166, the IED 174, the ICT 506 of FIG. 5), capable of performing the IED configurations of FIGS. 1-5. Processors 602-606 may include one or more internal levels of cache (not shown) and a bus controller 622 or bus interface unit to direct interaction with the processor bus 612. Processor bus 612, also known as the host bus or the front side bus, may be used to couple the processors 602-606 with the system interface 624. System interface 624 may be connected to the processor bus 612 to interface other components of the system 600 with the processor bus 612. For example, system interface 624 may include a memory controller 618 for interfacing a main memory 616 with the processor bus 612. The main memory 616 typically includes one or more memory cards and a control circuit (not shown). System interface 624 may also include an input/output (I/O) interface 620 to interface one or more I/O bridges 625 or I/O devices with the processor bus 612. One or more I/O controllers and/or I/O devices may be connected with the I/O bus 626, such as I/O controller 628 and I/O device 630, as illustrated.

I/O device 630 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system outlined in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in any applicable flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in any flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method for platform capability description (PCD) file-based configuring of intelligent electronic devices (IEDs), the method comprising:
generating, by at least one processor, PCD files for an IED, the PCD files stating capabilities of the IED, an International Electrotechnical Commission (IEC) 61850 data model, a license of functions of the IED for a user, and rules applying to settings of the IED;
generating, using an IED configurator tool from which IED rules are absent, based on the PCD files, a bundle of files for the IED, the bundle comprising a manifest and configuration files for the IED; and
providing, by the IED configurator tool, to the IED, the bundle, the license of functions, and the rules,
wherein the IED is configured based on the bundle, the license of functions, and the rules.

2. The method of claim 1, wherein the IED is a first IED of a first IED family, the method further comprising:
generating second PCD files for a second IED of a second IED family, the second PCD files defining a second configuration for the second IED, a second license of functions of the second IED for a second user, and second rules applying to settings of the second IED;
generating, using the IED configurator tool, based on the second PCD files, a second bundle of files for the IED, the second bundle comprising a second manifest and second configuration files for the second IED; and
providing, by the IED configurator tool, to the second IED, the second bundle, the second license of functions, and the second rules,
wherein the second IED is configured based on the second bundle, the second license of functions, and the second rules.

3. The method of claim 1, wherein the license of functions restricts the user to use of a subset of functions of the IED.

4. The method of claim 1, wherein the configuration files comprise a security configuration file, an applicative configuration file, and an IEC 61850 configuration file.

5. The method of claim 1, wherein the configuration for the IED comprises a file-based fully flexible IED data model with which the IED configurator tool configures the IED.

6. The method of claim 1, wherein the rules define which of the settings of the IED are to be available, hidden, or changed.

7. The method of claim 1, wherein the IED configurator tool is IED family-agnostic based on the PCD files.

8. An intelligent electronic device (IED) configurator device comprising memory coupled to at least one processor, wherein the at least one processor is configured to:
load platform capability description (PCD) files for an IED, the PCD files stating capabilities of the IED, an international Electrotechnical Commission (IEC) 61850 data model, a license of functions of the IED for a user, and rules applying to settings of the IED;
generate, based on the PCD files, a bundle of files for the IED, the bundle comprising a manifest and configuration files for the IED; and
provide, to the IED, the bundle, the license of functions, and the rules, wherein the IED is configured based on the bundle, the license of functions, and the rules, and
wherein IED rules are absent from the IED configurator device.

9. The IED configurator device of claim 8, wherein the IED is of a first IED family, and wherein the at least one processor is further configured to:
load second PCD files for a second IED of a second IED family, the second PCD files defining a second configuration for the second IED, a second license of functions of the second IED for a second user, and second rules applying to settings of the second IED;
generate, based on the second PCD files, a second bundle of files for the IED, the second bundle comprising a second manifest and second configuration files for the second IED; and
provide, to the second IED, the second bundle, the second license of functions, and the second rules,
wherein the second IED is configured based on the second bundle, the second license of functions, and the second rules.

10. The IED configurator device of claim 8, wherein the license of functions restricts the user to use of a subset of functions of the IED.

11. The IED configurator device of claim 8, wherein the configuration files comprise a security configuration file, an applicative configuration file, and an IEC 61850 configuration file.

12. The IED configurator device of claim 8, wherein the configuration for the IED comprises a file-based fully flexible IED data model with which the IED configurator device configures the IED.

13. The IED configurator device of claim 8, wherein the rules define which of the settings of the IED are to be available, hidden, or changed.

14. The IED configurator device of claim 8, wherein the IED configurator device is IED family-agnostic based on the PCD files.

15. A non-transitory computer-readable medium storing computer-executable instructions which when executed by at least one processor of an intelligent electronic device (IED) configurator device for capability description (PCD) file-based configuring of IEDs, cause the at least one processor to:
load platform capability description (PCD) files for an IED, the PCD files stating capabilities of the IED, an International Electrotechnical Commission (IEC) 61850 data model, a license of functions of the IED for a user, and rules applying to settings of the IED;
generate, based on the PCD files, a bundle of files for the IED, the bundle comprising a manifest and configuration files for the IED; and
provide, to the IED, the bundle, the license of functions, and the rules, wherein the IED is configured based on the bundle, the license of functions, and the rules, and
wherein IED rules are absent from the IED configurator device.

16. The non-transitory computer-readable medium of claim 15, wherein the IED is of a first IED family, and wherein execution of the instructions further causes the at least one processor to:
load second PCD files for a second IED of a second IED family, the second PCD files defining a second configuration for the second IED, a second license of functions of the second IED for a second user, and second rules applying to settings of the second IED;
generate, based on the second PCD files, a second bundle of files for the IED, the second bundle comprising a second manifest and second configuration files for the second IED; and
provide, to the second IED, the second bundle, the second license of functions, and the second rules,
wherein the second IED is configured based on the second bundle, the second license of functions, and the second rules.

17. The non-transitory computer-readable medium of claim 15, wherein the license of functions restricts the user to use of a subset of functions of the IED.

18. The non-transitory computer-readable medium of claim 15, wherein the configuration files comprise a security configuration file, an applicative configuration file, and an IEC 61850 configuration file.

19. The non-transitory computer-readable medium of claim 15, wherein the configuration for the IED comprises a file-based fully flexible IED data model with which the IED configurator device configures the IED.

20. The non-transitory computer-readable medium of claim 15, wherein the rules define which of the settings of the IED are to be available, hidden, or changed.
